(19) United States
(12) Patent Application Publication
(10) Pub. No.: US 2022/0340220 A1
(43) Pub. Date: Oct. 27, 2022

(54) Mobile Servicing Center

(71) Applicant: Bamidele Herbert Ali, Evanston, IL (US)

(72) Inventor: Bamidele Herbert Ali, Evanston, IL (US)

(21) Appl. No.: 17/241,068

(22) Filed: Apr. 27, 2021

(51) Int. Cl. B62D 63/08; B60L 53/31; B62D 63/06

(52) U.S. Cl. CPC B62D 63/08; B60L 53/31; B62D 63/068; B62D 63/061; B60L 2200/28; B60Y 2200/147; B60Y 2300/303; B60Y 2400/112; B60Y 2400/214

(57) ABSTRACT

A mobile automobile service and charging Center 50 with a trailer opening to intake multiple vehicles simultaneously by using multiple walls extending to the exterior used to lift and transverse automobiles to the interior for service. Interior mechanisms are hydraulic, magnetic, and air pressure operated to further lift and modify the position of the vehicle in service. The interior includes multiple electric charging stations, an interactive maintenance display center, multiple automated sensing devices used to detect car type and diagnose malfunctions, internal/external part delivery portals, lounge, a restroom, conference room, and mechanic sanitation areas. In all configurations the mobile automobile service and charging Center is a powered double decker, solar power supplemented mobile trailer. When dispatched for diagnostic and maintenance the Center will externally to the trailer or internally lift automobiles to an appropriate height based on the best ergonomic position for the mechanic and transverse the vehicles in to the mobile Center based on sensor feedback and mechanic biometrics. The Center provides multiple options for service from below or above the automobile, with floors that lower and a roof that will open to allow for above automobile servicing. Telescopic and piston driven support chairs and platforms are internally deployed to allow mechanics an efficient ergonomic seating, standing, or lying position to provide service without discomfort. Contained within the mobile service center are sensors designed to diagnose, track automobile location and service history, track tools and to display technologies to facilitate high efficiency automobile service; such as alternator replacements, oil changes, battery charging, hose replacements, spark plug replacements and other diagnostic, service, and charging services. All data gathered by the interactive service Center is logged and analyzed by intelligent predicting software to provide customers with the best performance and service data for each Automobile that enters and exits the Center.

### BACKGROUND OF THE INVENTION

### 1. Field of the Invention

This invention relates to a mobile Center for diagnostic, real-time integrated intelligent functional analysis, servicing, and charging for automobiles, and in particular, to an ergonomically structured high-efficiency service Center capable of multiple automotive services simultaneously by a single service provider or mechanic.

### 2. Description of the Prior Art

Automobile service is inevitable but obtaining service comes at an efficiency cost to worker productivity, puts additional automobile emissions in circulation in the form of loaner cars, and causes severe work related ailments to mechanics who work in less than ideal ergonomic configurations. Heavy or routine service performed on a vehicle is extremely inconvenient and causes the owner to not perform car service maintenance as often as needed to keep cars operating with efficiency and safety. More facilities providing specialized services such as oil changes and tire rotations have been implemented but these centers are open during normal business hours. This means that automobile owners must call off from work and work productivity to take their cars to a service center and either wait for the vehicle to be serviced or return at a later hour to pick up their automobile.

Additionally for service appointments that are not easily diagnosed, the mean-time-to-service (MTTS) varies vastly depending on mechanic experience, part availability, and type of automobile. This provides further inconvenience as owners now either need to facilitate an alternate means of transportation or they need to cancel the in-progress service appointment.

The lack of flexible service time offerings from existing facilities, most customers preferring to have their automobile serviced during lunch hours, drives a backlog of service orders. This means the automobile owners must often waits weeks for service. Furthermore, remote/onsite outdoor service providers are limited to the months of service, as inclement weather doesn't allow them to provide suitable service away from their service centers.

Service providers also complain about chronic back and shoulder injury due to poor ergonomic operating conditions. This causes the mechanic to introduce more billable work time into the service function, which cost automobile owners more money for service. This is yet another deterrent to seeking routine maintenance to keep existing cars in circulation for long periods of time.

To alleviate some of the inconvenience of travelling to distant automobile servicing facilities at inconvenient times, mobile automotive servicing facilities have been proposed. In some cases mobile mechanics have been proposed. The general idea behind such facilities and mechanisms is to provide a servicing facility that may travel to parking lots used by individuals during working hours, such as at large factories, office buildings, installations or shopping areas or other large public facilities where the automobile normally spends a great deal of time being idle. Example mobile servicing facilities are disclosed in U.S. Pat. No. 5,833,294 to Williams et al. and U.S. Pat. No. 4,981,318 to Doane et al. and U.S. Pat. No. 3,308,845 to Bellas et al.

Williams et al. discloses a mobile automotive servicing facility having a service facility with multiple lifts, a restroom, a customer waiting room/office and other amenities. A closed configuration with sidewalls, a roof and a floor. Sidewalls pivot to extend the roof on both sides. Inner walls pivot to extend the floor of the facility to the outside of the facility on both sides. The extended floor provides a ramp for ingress and egress of automobiles into the interior of the facility. Contained within the facility are automobile lifts and equipment for servicing the automobile, including oil changes and chassis lubrication, filter replacement, wiper blade replacement, belt replacement and additional services.

Doane et al. discloses a mobile service facility including a frame, having a floor, a forward end, a rearward end, and spaced sides extending between the ends. A roof overlies the floor. An entrance for an automobile is provided at the forward end of the apparatus. Corner post assemblies are positioned adjacent the forward end of the frame and on one side of the frame for maintaining the roof space above the floor. Each corner post assembly is movable between a closed position for travel and an open position in which the forward end is widened so that a vehicle wider than the spaced sides of the frame may be driven onto the floor without interference from the corner post assemblies. The spaced side walls disclosed in Doane et al. are extendable so that a vehicle wider than the spaced sides in the closed configuration may be driven onto the floor.

Bellas et al. discloses a mobile automotive servicing facility having a van body portion consisting of side wall portions, a front wall portion, a back portion, and top wall portion. An entrance is provided at the back portion of the van body for ingress and egress by an automobile. A lift is provided to receive the automobile entering through the rear entrance. Extendable top portions and side portions of the van body may be pivoted to extend the top and width of the van body for servicing the automobile.

Williams et al., Doane et al., Bellas et al. and other prior mobile servicing facilities have several challenges and thus have not been largely implemented nor adopted for use. For example, these prior facilities have failed to provide a suitable efficient work environment for service providers to work effectively on vehicles in a safe manner. They have attempted to incorporate the customer in to the service process by providing onsite amenities but being inside of a mobile service facility though just outside of their primary work location or domicile does not improve owner work productivity nor convenience. The inconvenience and reduced productivity is thus shifted primarily to the mechanic or service provider making the mobile less viable for practical use.

Additionally prior mobile service facilities have not addressed the inefficiencies in obtaining service parts on demand at such remote sites. They have not integrated diagnostic and intelligent software in to the mobile service facilities to reduce errors, decrease service time for both mechanics and automobile owners, and to create customized predictive data and insights for future service provisions. Also the mobile facilities have not become self-sustained automobiles themselves and thus require additional natural resources to function in a remote mobile capacity.

In light of these shortcomings, a need exists for a mobile automobile servicing and charging facility with integrated intelligent capabilities to efficiently capture data, diagnose and analyze said automotive data, provide ergonomically superior operating conditions for service providers and operate both during normal work hours and during non-traditional work hours to provide convenience and decrease mean-time-to-service (MTTS) for automobile owners.

### SUMMARY OF THE INVENTION

One aspect of the invention described herein noted the provision of an improved mobile automotive servicing and charging Center. The Center has a frame, such as a frame custom designed to fully integrate electrical wiring and pivoting sections with lighting, electrical sockets, etc. on the inner and outer portions of the frame. The frame supports a floor and a roof overlying the floor. Sidewalls extend from the floor to the roof on opposite sides of the frame to fully enclose the interior area of the servicing facility. At least one opening is provided in the side of the facility for ingress and egress by automobiles to and from the interior of the facility. The rear and side wall serves as dual functionality of enclosing the Center and pivoting and lower to provide a lift and service storage surface for automobiles. The walls can pivot and traverse vertically and horizontally to change the orientation the automobile to be serviced. The frame and walls of the center have integrated cameras and lighting for around the clock operation and user security.

The present invention provides a mobile center that lifts multiple cars inside of said Center while automatically diagnosing the automobile prior to entry and after, logging the critical meta-data, and setting up the vehicle for efficient service from the service provider or mechanic. The Center is preferably a customized trailer capable of receiving vehicles in a partially closed or open position, which can be legally towed or driven over public roads. The mobile service center can be deployed around the clock to residential and commercial areas.

In one embodiment of the invention the outer walls and roof of the mobile center houses multiple solar panels used to, power service tools, to charge the mobile unit batteries, to charge service vehicles, and to power other electrical devices inside of the mobile service center. The solar panels pivot out from the outer walls and the roof of the service center to optimize light receipt. Solar panels retract and extend to ensure they do not interfere with service automobile entry or exit in to the mobile center.

In one aspect of the invention described the mobile center sides walls which are also used to lift automobiles in to the center for servicing has integrated lights, sensors, cameras, and microphones used to record automobile performance data. The integrated lights are used to sense surface cracks in, on, and around the automobile. Separate lights are used to illuminate the automobile, lift, and service center for ease of viewing and security. The mobile center side wall lifts with integrated, lights, sensors, cameras, and microphones, records, stores, receives, and transmits data to and from the mobile center computer units for storage, analysis, and feedback of the automobile's location in relation to the service center, automobile service history, probable faulty parts, structural integrity abnormalities, and other diagnosed automobile data to the mechanic or service center provider.

In one embodiment of the invention the outer walls and inner work areas of the mobile service center has intelligent cameras. The outer wall cameras are used to detect and record any unauthorized persons in or near the mobile service center for both safety and security reasons. The inner cameras are also used for security purposes but primarily allow dispatch operators to remotely monitor mechanics and services providers inside the mobile center, ensuring their safety and alertness throughout the automobile service engagement.

In one aspect of the invention described the mobile center's monitors and displays provide visual and audio references for mechanics to follow in order to provide more efficient automobile services. The mobile center display receive and interpret data provide by any external or internal car diagnostic analysis tool to cross reference with existing automobile data. The mobile center displays and computers are also responsible for storing and analyzing newly gathered automobile data for predictive maintenance and service needs. The mobile center computers can automatically communicate with dispatch and/or the auto parts suppliers to procure allocate and procure probable parts needed for service before and after the automobile fully enters the service center.

To provide a protective service environment, a retractable awning extends out from the mobile service center sidewalls and rear entry, allowing mechanics to provide semi-eternal or fully external, to the mobile center, automobile service. Furthermore HVAC functions are fully integrated in to the center for suitable environmental control.

### BRIEF DESCRIPTION OF THE DRAWINGS

FIG. 1 is a perspective view of a preferred embodiment of a mobile service center in accordance with the present invention;

FIG. 2 is a perspective view of the mobile service center of FIG. 1 without solar panels shown in a configuration for intake of a vehicle to internally service in position 4;

FIG. 3 is a side view of the mobile service center of FIG. 1, shown in a configuration for intake of several vehicles for service in all 4 positions including atop the automobile supports and reinforced toolboxes;

FIG. 4 is a side view of the mobile service center of FIG. 1, shown in an open configuration with cars in 3 of 4 potential service locations, a spiral staircase for mechanic access to above the automobile services, human egress, ingress doors;

FIG. 5 is a rear view of the mobile servicing center shown in FIG. 1 illustrating the rear intake ramp sensors, camera, and vibratory diagnostics as well as the moveable ergonomic mechanic chairs;

FIG. 6 is a perspective view of the mobile servicing center shown in FIG. 1 in an open configuration illustrating mechanics in all 4 serviceable areas, including the self adjust center floor, and the electric vehicle powering stations;

FIG. 7 is a side view of the mobile automotive center shown in FIG. 1 in a closed configuration illustrating the center's solar panels and part receipt storage units along the base of the trailer;

FIG. 8 is a perspective view of the mobile servicing center shown in FIG. 1 in an open configuration illustrating the automobile support units above the part receipt and storage compartments along with the upper level side mounted mechanic lay platforms and side mounted extendable work lights;

FIG. 9 is a bottom view of the mobile servicing center shown in FIG. 1 illustrating the center's electric battery configuration;

FIG. 10 is a perspective view of the mobile servicing center shown in FIG. 1 in an closed configuration illustrating the semi transparent side service doors and external security and automobile detection cameras;

FIG. 11 is a side view of the mobile servicing center shown in FIG. 1 in an open configuration illustrating the center's open roof system;

FIG. 12 is a perspective view of the mobile servicing center shown in FIG. 1 in an open configuration illustrating the automobile supports and the mechanic toolboxes, rear door pivots and rear door lift platform;

FIG. 13 is a perspective view of the mobile servicing center shown in FIG. 1 illustrating the automobile supports and the mechanic toolboxes, spiral staircase, interactive service display, upper service platform, front area mobile lift system;

FIG. 14 is a top view of the mobile servicing center shown in FIG. 1 illustrating the front area mechanics conference room and internal bathroom;

### DETAILED DESCRIPTION OF THE PREFERRED EMBODIMENTS

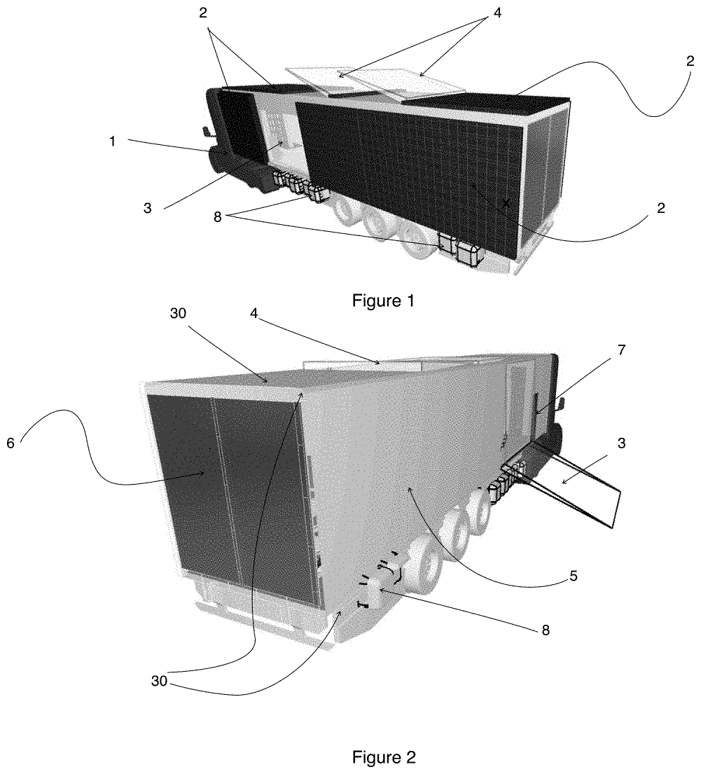

In reference to the drawings, FIG. 1 shows a perspective view of a preferred embodiment of a mobile automotive servicing center 50 in accordance with the present invention, wherein the center is in a closed configuration to protect service personnel from the elements and to allow efficient ergonomic movements inside the novel center's service area 27. The mobile automotive servicing center is a customized 53-foot trailer design to be towed or pulled by a secondary vehicle 1, preferably an electric semi-truck vehicle. Center 50 is formed from multiple novel sidewalls 29, a novel roof 30, a novel frame 31, and a custom modular moveable interior floor 15. The center's core sandwich structure walls 29, 30 is made from lightweight materials to accommodate an electric or economy gasoline fueled towing or pulling vehicle 1.

The center's sidewalls 29 are 53′ long, symmetrical in exterior configuration and are composed of lightweight composite materials with hinged doors 7 A/B that allow for human ingress or egress. The center's external sidewalls are also configured with a pivoting sealable doors 3 A/B which pivot down to the center trailer wheels at ground level to allow serviceable automobiles 34 to drive up and in to the mobile service center 50 for service. Once the automobile is driven on to the side service doors 3A in their downward 330° degree pivot position, the listening devices are active such that the automobile's sounds and vibrations while in the ‘on’ or running state can be recorded, analyzed, and stored by the onboard computer system for future use. Multiple embedded microphones 11 are listening to the automobiles sounds and cross referencing those sounds via a proprietary algorithm stored in the onboard computer to predict and assist in determining what failure(s) currently exist in the automobiles functionality and what future failures may occur according to a predictive service algorithm also stored in the onboard computer system. The mechanic while inside of the serviceable automobile will receive meta-data and service instructive information from the service center displays 20 related to the serviceable automobile being loaded in to the center service area 27. The service center displays are reading out the automobile's diagnostics information as well as specification information on the make, model, year manufactured, service history, and potential failures. Also in the side service doors are multiple vibration sensors 12 which also provide diagnostic information, based on the vibratory frequency of various regions of the car, to the mechanic for efficiency of service. The vibration sensors 12 capture automotive vibration data and compare it to non-malfunctioning vibration datasets stored in the onboard computer database; to an exact match in the serviceable automobile, year, make, and model. The analyzed vibration data is provided to the mechanic in multiple locations via the service center displays 20 for efficiency of service. The side service doors contain multiple cameras that capture, analyze and transmit images of the car looking for structural damage and missing mechanical parts of the automobile.

The Center's roof is 53′ long, 8.5′ in width and is composed of sandwich structured composite materials, preferably ribbed structured polymer-metal composites. The roof service door 4 in it's closed configuration houses solar panels 2 and multiple pivoting panels used to facilitate center ventilation and openings for automotive service. The roof's pivoting service and ventilation doors 4 are 8′ wide and 10′ long. The roof doors pivot from 180° degrees to 90° degrees and seal at 180° in the closed configuration to prevent moisture ingress. The center roof pivoting doors 4 are semi-transparent to allow natural light to permeate the center's service areas 27. The internal walls 43 of the roof have recessed lights 44 to provide additional lighting for the mobile servicing area 27.

The center's left and right side external walls are covered with pivoting and rotating solar panel materials 2 attached to the wall 29 surfaces. The center's left side and right side wall each are 40′ in length and are 11′ in height of attached pivoting and rotating solar materials 2. The center's roof has 30′ in length of pivoting and rotating solar panels 2. The solar panels are 25′ in the front section of the trailer external roof 30 and 5′ in the rear of the center's external roof 30.

The center's chassis contains the trailer's power units 52, which is either a gasoline or electric powered to provide energy to the center's service area equipment and moveable support structures. The mobile service center's sandwich structure walls 29, 30 contain the center's electrical wiring, sensor controls, communication cabling, routed fluid removal and storage hoses.

FIG. 1 is a perspective view of a novel mobile service center 50, FIG. 1 exterior has multiple solar materials 2 used to power the customized service center area 27 and the internal mechanisms of mobile service center, including security and diagnostic cameras 10. The solar materials 2 cover all external surfaces including vehicle center trailer doors, 3, 4, 6, 7. Center 50 is formed from multiple custom sidewalls 29, a custom roof 30, with electrical distribution systems routed in between the panels of said roof, sidewalls, and flooring, a custom frame 31, all used to support solar materials 2 and to protect the internal service center area 27, the mechanics 51, and serviceable automobiles 34, from the elements or any human disturbances.

The mobile servicing center 50, FIG. 2, shows a perspective view of a mobile servicing center with a roof 30 containing two pivoting sealable roof doors 4 designed to open for both automobile ventilation and to allow mechanics 51 full access in an “under the hood position” to said serviceable automobiles such that the mechanics can provide service from above the automobile. This allows unobstructed access to the serviceable automobile 34 parts from above without damaging the hood of the serviceable automobiles 34.

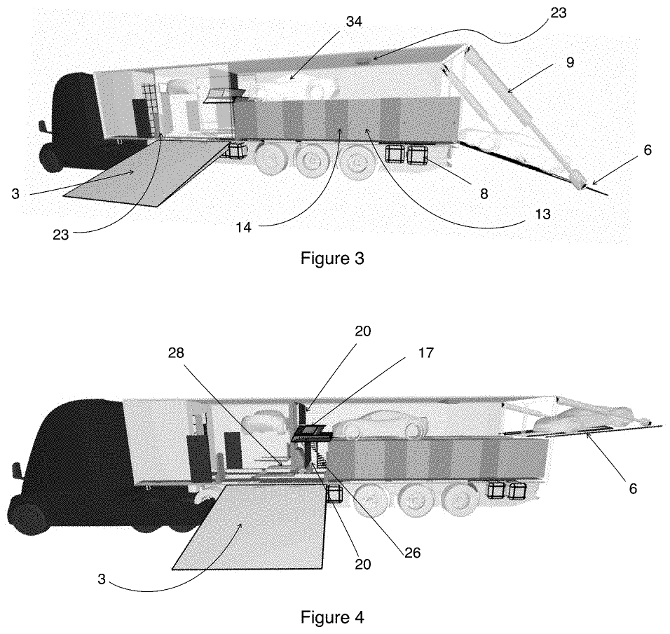

FIG. 3 the mobile servicing center 50 open configuration of sidewalls 29 are connected to the rear piston driven lift platform automobile entry door 6. The rear piston driven door lift platform 6 is used to onboard automobiles for service from the rear of the center 50. The rear piston driven door lifts automobiles from ground level to a height level with or above the toolbox supports 13 and car supports 14 which are made from high performance structural steel to hold the automobiles during service by the mechanics. The rear piston driven door lift 6 also provides a seal of the center's 50 rear area for protection from inclement weather. The rear door 6 is also configured with several diagnostic devices designed and positioned to analyze an automobile's service needs before, during, and post service. The door lift 6 is configured with a retractable center plate 33. FIG. 4., which allows a fourth car to be serviced while the rear lift platform 6 is in an elevated position such that the mechanic 51 can work beneath the automobile to be serviced as illustrated in FIG. 4.

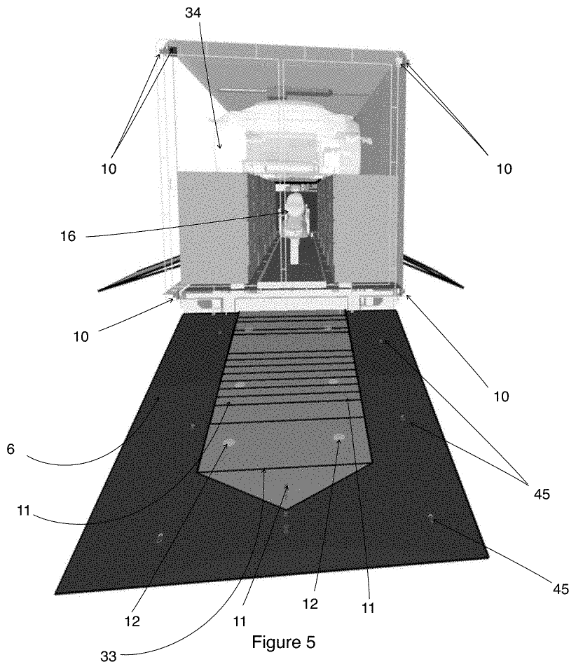

FIG. 5 shows a perspective view of the mobile service center in an open configuration with the rear door lift platform 6 down to receive a vehicle for service. Once the mechanic drives the automobile on to the platform 6, diagnostic analysis begins before the lift platform 6 is elevated in to the upper level position to move the automobile inside the mobile service center 50, service area 27. While the automobile is the rear door lift platform 6 the listening devices are active such that the automobile's sounds and vibrations while in the ‘on’ or running state can be recorded, analyzed, and stored by the onboard computer system for future use. Multiple embedded microphones 11 are listening to the automobiles sounds and cross referencing those sounds via a proprietary algorithm stored in the onboard computer to predict and assist in determining what failure(s) currently exist in the automobiles functionality and what future failures may occur according to a predictive service algorithm also stored in the onboard computer system. The mechanic while still inside of the car will receive meta-data and service instructive information from the service center displays 20 related to the serviceable automobiles. The service center displays are reading out the automobile's diagnostics information as well as specification information on the make, model, year manufactured, service history, and potential failures. Also in the rear lift door platform 6 are multiple vibration sensors 12 which also provide diagnostic information, based on the vibratory frequency of various regions of the car, to the mechanic for detailed efficiency of service. The vibration sensors 12 capture automotive vibration data and compare it to non-malfunctioning vibration datasets stored in the onboard computer database, an exact match in automobile make and model. The analyzed vibration data is provided to the mechanic via the service center displays 20 for efficiency of service. The rear door lift platform 6 also contains multiple cameras 45 that capture analyze and transmit images of the serviceable automobile looking for structural damage and missing mechanical parts of the automobile.

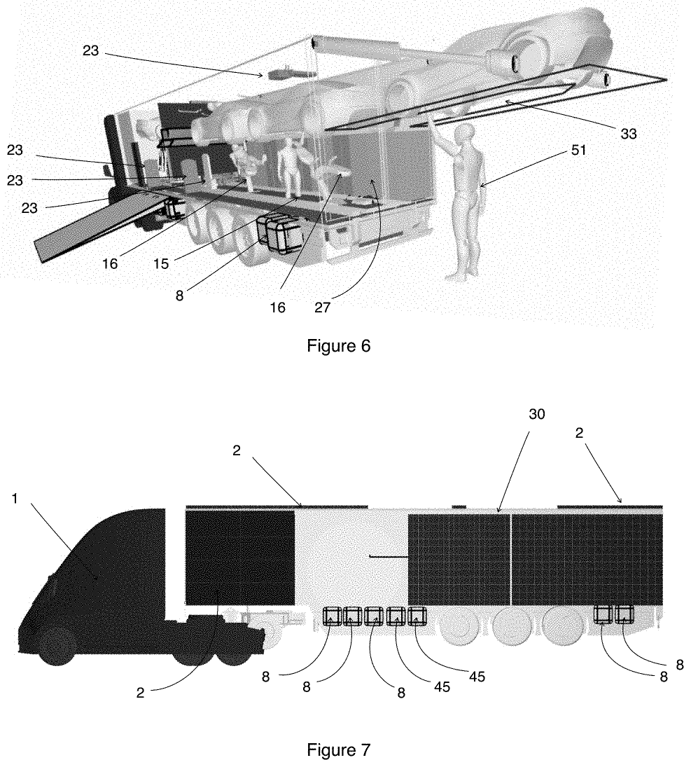

The rear door lift platform 6 has a retractable center plate region 33, which allows a vehicle to be serviced from an upper elevated position. FIG. 6. In this position a service mechanic can stand on the ground and service a fourth vehicle stationery on the rear door lift but remaining external to the mobile service center.

In the open configuration the mobile service center's 50 rear door lift platform 6 is initially in the down position such that serviceable automobiles can be driven on the to the platform. Once the platform completes the automobile's diagnostics via the cameras 45, vibration sensors 12, and microphones 11 the lift gate pistons 9 raise the rear door lift platform 6 to an upper elevated position so that the retractable center plate can be retracted for service or so that each automobile can be moved forward in to the mobile service center service area 27.

FIG. 7 the side view of the mobile servicing center has 14 part delivery compartments 8 below the sidewalls 29 and center frame 31 external to the center trailer 50. The part delivery compartments 8 can be opened on both ends but are locked and only opened by delivery code in order to place service parts inside of said compartments from a place external to the mobile service center 50. The part delivery compartments 8 open externally to the center 50 such that parts can be placed inside, by delivery suppliers directly to the mobile service center, the compartment securely for future recovery from inside the service center area 27. The opposite side of said compartment 8 can be open from inside the Center service area 27 from just above the center's moveable floor 15.

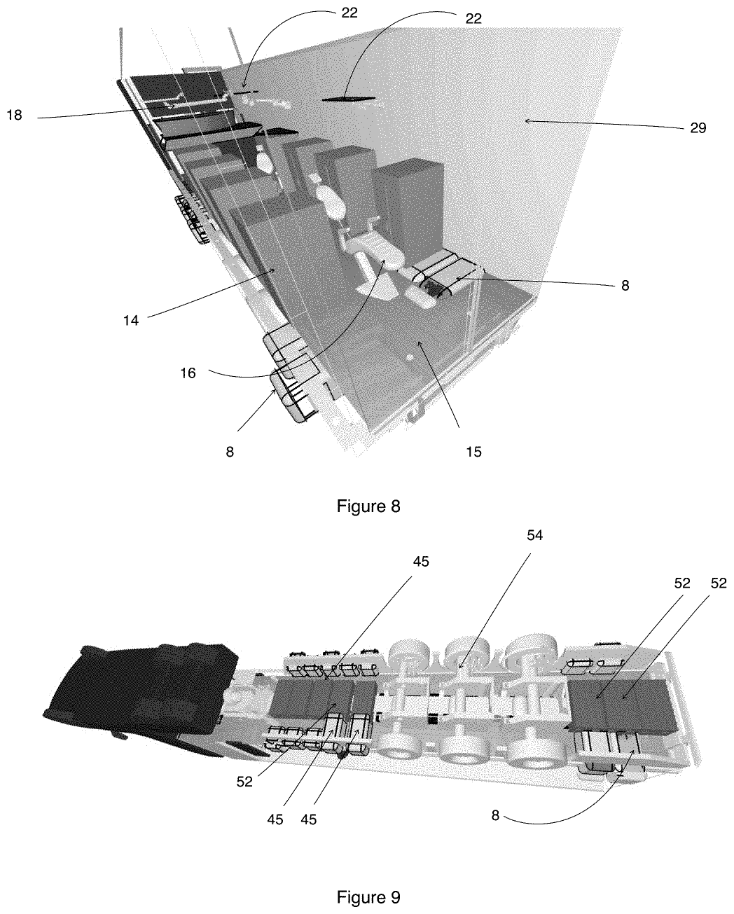

FIG. 8. The configuration will allow 3^{rd} party service part deliveries while mechanics 51 are servicing other service vehicles such to not interrupt current service activities allowing for more efficient servicing of automobiles 34. The configuration provides a secure entry point mechanism for part delivery to the center without exposing mechanics to external persons that may try to access the internal service area 27.

FIG. 9 is a bottom view of the mobile service center's battery power unit 52. Each of the trailers 8 power units is capable of a 10 kW power output. The power units 52 are connected in parallel or independently to various device in the mobile center 50 service area 27, including the central computer system, the moveable floor 15, moveable mechanic chairs 16, the rear lift platform door 6, the center roof access doors 4, the side service doors 3, the fluid 45, part storage 8 compartments, the mobile center's lighting 53, the forward conference room area 24, and mechanic's bathroom area 25. The trailer battery power units 52 are equally spaced at the center and rear center inline with the mobile service center axels 54.

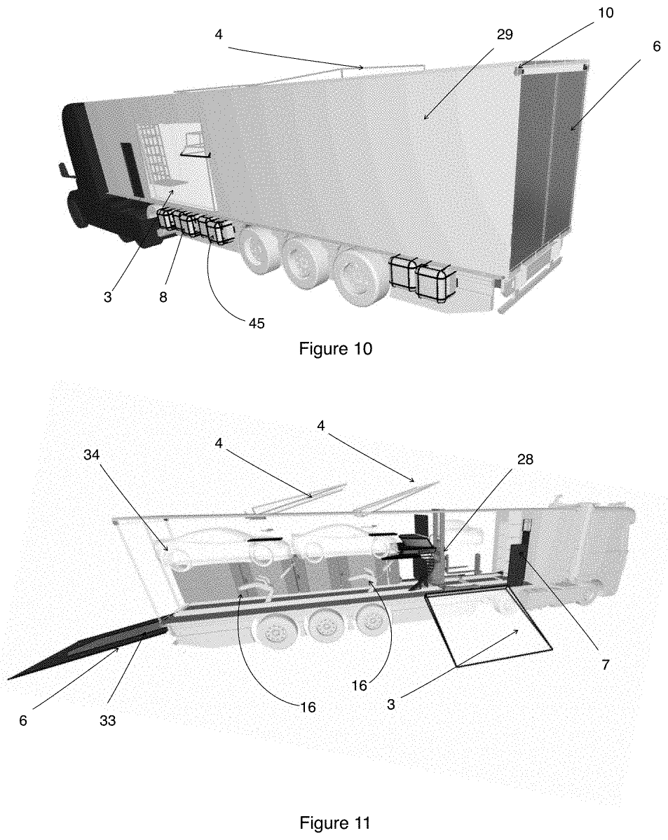

FIG. 10 is a perspective view of the mobile service center with external cameras 10 mounted to the frame 31. Each camera mounted at the 8 corner surfaces, 4 on the rear center lift platform 6 outer surface, 4 on the right center's wall facing outward and 4 on the left center's wall facing outward of the trailer 50. The cameras 10 are used for security and automobile detection such that each cameras can recognize the make and model of an automobile and register that data in to the onboard mobile service center computer system. Each camera can recognize various mechanic faces and some medical conditions of each mechanic to provide real-time location and health feedback to the mobile service center's central dispatch. There are multiple cameras on each corner of the center's trailer left external walls 29, multiple cameras on the center's right trailer external wall, multiple cameras 10 on the rear lift platform 6 in the closed configuration and multiple cameras 10 on the center's roof. The internal service area is equipped with several cameras 10 positioned to monitor, in real-time, the mechanics movement and safety in the service area 27. Each camera 10 is controlled independently and provides a live stream of video and image data to a central dispatch representative for real-time monitoring and support.

FIG. 11 is a side view of the mobile service center's side service doors 3a and 3b, which are semi-transparent to allow natural daylight to enter the service center area 27, during daylight hours. The mobile service center sidewalls 5 have ingress and egress doors 7a and 7b to allow mechanics to enter and exit the trailer without opening the side service doors 3a, 3b. The side service doors pivot down to the ground level to create an inclined ramp allowing serviceable automobiles to be driven up and in to the center on to the mobile lift device 28. In the forward service position automobiles can be lifted to a height of 7.5 feet above the center's floor 15, for service by a mechanic. The 2 parallel side service doors 3a, 3b can remain open while each automobile is in an active service position. The side service doors 3a, 3b are 6′ wide and 9′ tall. The doors pivot from 90° degrees down to 330° degrees or −30° degrees. The 2 side doors for human use can be used to allow mechanics to exit the center area 27 in case of emergency or in case the mechanic needs to exit to reach the drivers cab area.

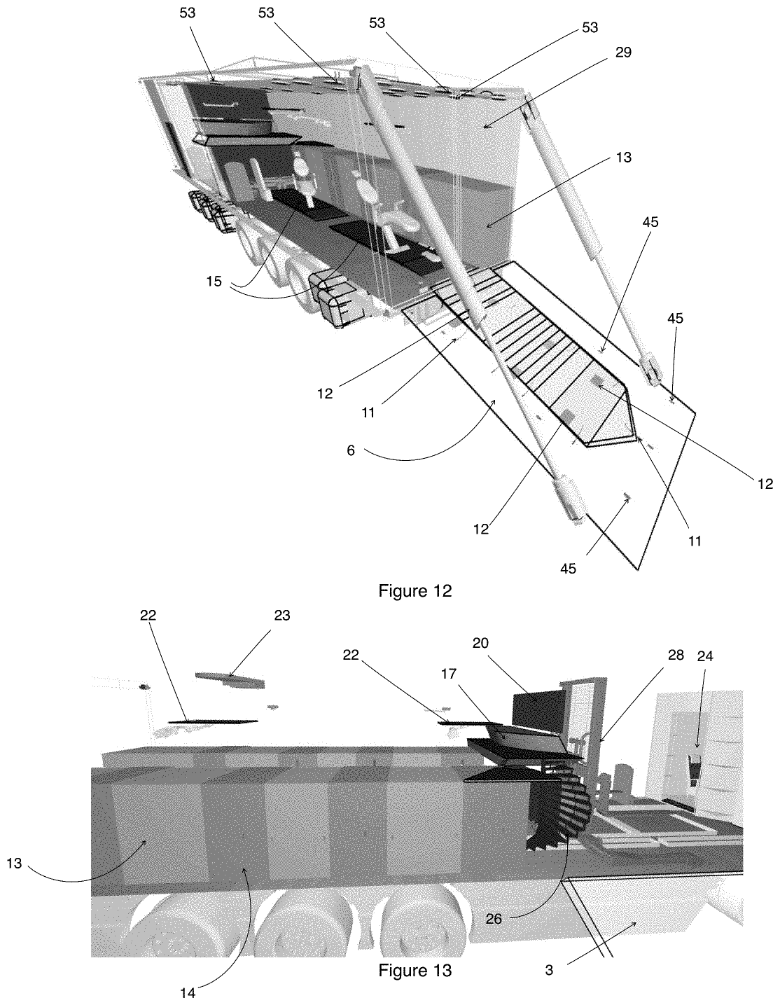

FIG. 12 is a perspective view of mobile service center with multiple serviceable automobiles in the closed configuration. The center's floor 15 in multiple sections recesses down on a slanted slope or stair step by 20″ from the level of the bottom of the automobile support structures and toolboxes. The center's floor 15 automatically adjusts up and down based on the height of the mechanic in relation to the various areas of the automobile in need of service. The recessible sections of the floor 15, are 10 feet in length and 30 inches wide. Each section of the centers floor 15 which is 50 feet in total length and 4 foot in width with smaller sections that move up and down in the z-direction to create the most efficient ergonomic position to service the automobile given the mechanics height and need for physical leverage to provide service. The moveable sections have a rotating cylindrical mechanism with the recessible floor integrated in to the cylinder 55. The cylinders rotate 55 plus or minus 30 degrees causing the respective moveable floor to raise and lower for 10 inches inclination to minus 20 inches of declination. The floors 15 have recessed work lights installed to provide illumination for the service area 27.

The outer boundaries of the recessible floors 15 provide access to the internal portion of the part receipt access doors 8. This allows for parts to be received from delivery supply centers or service partners. Mechanics can retrieve delivered parts from the part delivery compartment internal to the center's service area 27. The part storage compartments 8 also store old parts for future removal from the center.

There is several fluid storage and distribution compartments 45 designed to hold, extract, and distribute old automotive fluids to and from serviceable vehicles for future removal from the center 50. Multiple storage compartments 45 hold new useable fluids, like transmission fluid, brake fluid, and motor oil etc. Each fluid storage and distribution compartments 45 contains a funnel system using gravity and reverse osmosis techniques to easily extract or deposit fluids to and from the storage compartments.

The service area has multiple electric vehicle power stations 23 used to power or recharge electric serviceable automobiles 34.

FIG. 13 is a perspective view of the center 30 showing generally the layout of the interior 27, mainly the mechanic service chairs 16 and the mounted-charging units 23. The mechanic service chairs 16 fold to a horizontal flat position for storage when not in use. The chairs also lower to a central floor 15 recessed positions when not in use. During automobile service the mechanic service chair 16 unfolds to an ergonomic position allowing the mechanics to sit or partially lay in the chair during service. Each mechanics service chair 16 moves by hand controller unit with x, y, z and yaw degrees of freedom. This will allow the mechanic to reposition his/her body efficiently during service each serviceable automobile while minimizing back injury and fatigue.

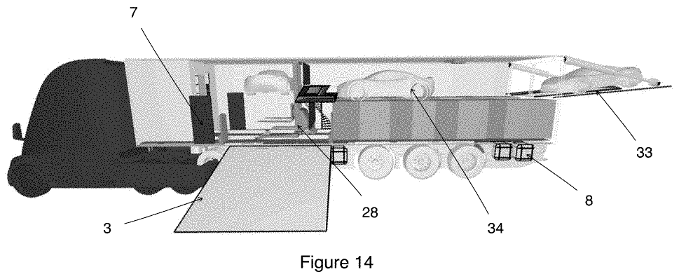

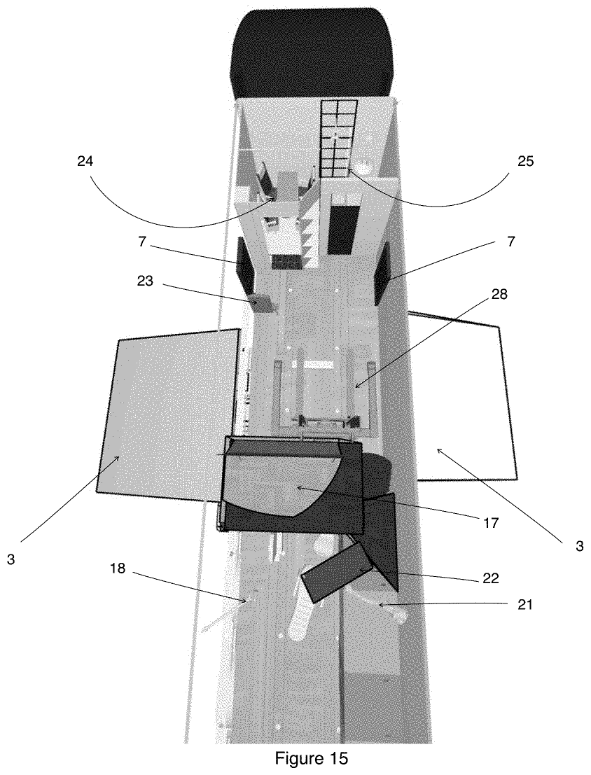

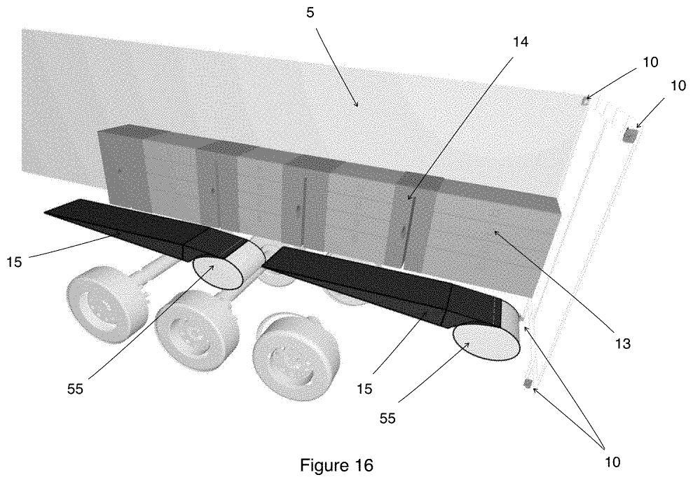

FIG. 14 is a side view of the automobile support structures 14 and toolboxes 13. From the upper rear service door 6 position a serviceable automobile 34 will be moved on to the internal automobile service supports 14 and steel/aluminum-reinforced toolboxes 13. These toolboxes 13 and automobile supports 14 serve to hold up to 2 serviceable automobiles simultaneously. The toolboxes 14 provide both automobile support as well as holding multiple tools used to serviceable automobiles. The automobile support structures have functional power and communication ports embedded for use in the mobile center service area 27. Each toolbox 14 can be shifted outward through the center left and right walls 29 to provide addition service area 27 space or each toolbox can remain in its existing location relatively aligned with the service support structures during service activities. Each toolbox 13 has sensors that identify and detect tools to ensure that every tool is accounted for and located in a position that is most efficient for the mechanics.

The mobile service center has a spiral staircase 26 in the general center area 27 to maximize useable space. The spiral staircase 26 allows mechanics to move to the second level to service each vehicle from above the vehicle if needed. In the forward area of the center is a portable automobile lift 28 used to elevate a 3^{rd} vehicle in to a serviceable position. This portable automobile lift 28 can be moved to various locations of the forward mobile center's service areas to accommodate mechanic preference of service orientations and various vehicle types, which may require different levels of space for efficient service.

The upper level platform 17 is bracketed to the spiral staircase 26 and supported a single central column structure. The upper level platform 17 is an open area low head clearance seating space with an attached display 20 above the platform for mechanic viewing. Above the center's floor 15 is a work platform in the center of the service area 27. The platform is a centralized hub for the mechanic to work on the serviceable automobile in the 2^{nd} position—to be serviced from under the hood above the automobile 34 while the vehicle is at rest on the automobile supports 14. Mechanics can analyze the cars performance from the upper service platform and use this area to store tools and parts prior to installation.

As an alternative servicing mechanism multiple laying platforms 22 are installed in the sidewall 29 of the service center mobile center trailer 30. The laying platforms 22 allow mechanics to lay face down in an ergonomic position from above the automobile 34. The laying platforms' 22 movements are controlled electronically, which allows the mechanics to reposition their bodies for comfort, leverage, and general ease of service.

Attached to the sidewalls are multiple extendable actuator and pivoting control arms 18 with service lights 19 installed at the end of this extendable mechanism.

FIG. 15 is a top view of the mobile service center with the forward car lift designed to provide an area for a 3^{rd} car to the serviced at least inside the mobile servicing center in a semi-closed configuration. In the forward area of the Center service area is a conference room 24 to hold mechanics meetings and communications with central dispatch and other mechanics for secondary technical support. The conference room also houses a folding bed and hammock for mechanics to take a rest periodically during the workday. Next to the conference room area is the full bathroom 25 for mechanics. The bathroom houses 25 a full shower, vanity, toilet, and a hand-eye rinse center.

While the present invention has been described with respect to specific embodiments thereof, it will be understood that various changes and modifications will be suggested to one skilled in the art and it is intended that the invention encompass such changes and modifications as fall within the scope of the appended claims.

What is claimed is:

1. A mobile automotive servicing and charging center comprising:
a light-weight semi-porous frame;
a modular expanding and contracting floor supported by said light-weight semi-porous frame;
a retractable and pivoting roof supported by said frame;
a moveable side walls extending from said floor to said roof on opposite sides of said frame to enclose said mobile servicing and charging center;
an outer moveable rear and side walls attached to said frame to extend both horizontally and vertically between a closed position wherein said outer side wall sections are rotating through multiple degrees relative to said fixed side walls and an open position wherein said outer side wall sections are rotating through multiple degrees relative to said side walls;
an outer wall that extends and lowers to ground level to lift and transverse automobiles to be serviced;
an inner retractable wall that extends in the rear to cover the opening left by the traversed rear wall supporting the lifted automobile;
a frame, side walls, and roof containing multiple multi-axis moveable solar panels affixed to said roof, walls, and rotating, recessible, and retractable doors.

2. The Center of claim 1 wherein said split platform is lifted with serviceable automobiles vertically by hydraulic, electric, or manual screw to the level of the service toolboxes and car supports where the automobile is moved in to the mobile service center for service.

3. The Center of claim 1 wherein said moveable side wall is connected with a pivoting hydraulic mechanism to allow automobiles to enter the center perpendicular to the forward center automobile lift area for service.

4. The Center of claim 1 further comprising a plurality of hydraulic pistons below a magnetic lift system and customized lift pads for vertical lift and horizontal transport of automobiles in to service position. Said hydraulic magnetic pistons having directed service lights, and lockout mechanisms to disallow piston retraction during service.

5. The Center of claim 1 comprising of a telescopic arm extending from the base of the service center floor holding a service chair. Said service chair is electric or battery powered with controls to move horizontal, vertical, roll, pitch, and yaw.

6. The Center of claim 1 comprising of a telescopic arm extending from the base of the service center floor and sidewalls with an affixed work light. Said telescopic arm with attached work lights has multidirectional electric and manual movement in horizontal, vertical, roll, pitch, and yaw.

7. The center of claim 1 further comprising of stairs that ascend above the service vehicle inside of said center. A telescopic arm holding a platform extends from the Center roof or the sidewall, which allows the mechanic to service the vehicle from a horizontal orientation.

8. The center of claim 1 further comprising a plurality of service toolboxes each of which are re-enforced structures to support automobiles during service, affixed to the center's sidewalls extend out from said vertical sidewalls of the center.

9. The Center of claim 8 wherein each of said service toolboxes has light, magnetic field emitter/receiver, and RFID sensors which detect, transmit, and record the entry and exit of each tool from each tool box and the center service area.

10. The Center of claim 1 further comprising a light, camera, magnetic field emitter/receiver, and RFID sensors at all entry and exit doors to detect, transmit, record, and diagnose the entry and exit of tools and automobiles and the technical integrity of the tools and automobiles.

11. The Center of claim 1 further comprising of walls, ceilings, and floors with integrated light, motion, magnetic, and RFID sensors used to detect, diagnose, and transmit automobile, make, model, ownership, warranty, service history, and operational integrity.

12. The Center of claim 1 further comprising a retractable roof made to open during the servicing of automobiles from above the automobile with the hood open.

13. The Center of claim 1 further comprising a plurality of integrated biometic sensor, video, audio, cameras both on the inside and outside of said Center used for service, security, and communication between components mechanics and mobile service dispatchers.

14. The Center of claim 1 further comprising a plurality of monitors, which display automobile and tool details, location, part supply information and service demonstration videos within said Service Center.

15. The Center of claim 1 further comprising a plurality of external and internal storage compartments with light, RFID, and magnetic sensors to detect the entry, removal, and type of parts or fluids in said compartments.

16. The Center of claim 1 further comprising a plurality of electric automobile charging centers within said Center to recharge and power electric automobiles.

17. The Center of claim 1 further comprising multiple extendable service awnings used for service vehicles within 20 feet of said Service Center.

18. The Center of claim 1 wherein said Center walls has a plurality of solar panels attached to said Center external walls and external roof, used to power, recharge, and service said Service Center, automobiles, tools, displays, sensors, cameras, and other Service Center amenities.

19. The Center of claim 1 wherein said Center walls, framing, and flooring, used for lifting and enclosing automobiles in to center have a plurality of diagnostic microphones, cameras, and vibration sensors used to listen, record, and store automobile information for service efficiency and predictive maintenance software.

20. The information collected from the Center of claim 1 is linked with mobile phone software to allow automobile owners and mechanics to diagnose car functionality and performance from sound, vibration, image, and other meta-data.

21. The Center of claim 1 wherein said Center is used for the display and sale of cars with side walls that open to display automobiles for potential customers.

22. The Center of claim 1 computer systems collect and display service support data transmitted and received from center sensors relating to the car or mechanic safety. The computer systems also use diagnostic data and mechanics' input to automatically or at least predictively allocate or procure service parts from dispatch or part suppliers.

23. The Center of claim 1 has integrated inner and outer wall cameras used to monitor unauthorized persons from entering or getting too close to the facility. Inner wall cameras are used for security but they are primarily used to enable dispatch to monitor mechanic safety.
